(19) United States
(12) Patent Application Publication
(10) Pub. No.: US 2016/0174465 A1
(43) Pub. Date: Jun. 23, 2016

(54) VARIABLE SPEED DRIVE SYSTEM FOR GRAIN UNLOADING

(71) Applicant: AGCO Corporation, Hesston, KS (US)

(72) Inventors: Kevin N. Kohls, Hesston, KS (US); David W. O'Reilly, Hesston, KS (US)

(21) Appl. No.: 14/978,018

(22) Filed: Dec. 22, 2015

Related U.S. Application Data
(60) Provisional application No. 62/095,932, filed on Dec. 23, 2014.

(51) Int. Cl. A01F 12/58; A01D 41/127; A01F 12/46; A01D 69/03; B65G 67/24; A01D 41/12; A01D 69/06

(52) U.S. Cl. CPC A01F 12/58; A01D 41/1208; A01D 41/1274; A01D 69/06; A01D 69/03; B65G 67/24; A01F 12/46; A01D 2101/00

(57) ABSTRACT

In one embodiment, a system comprising: a planetary gear set configured to receive plural inputs and provide a variable output, the plural inputs comprising a first input and a second input; a motive system comprising an engine; a first clutch coupled to the motive system and configured to provide the first input; a variable speed drive system coupled to the motive system and configured to provide the second input; and an unloading system operatively coupled to the output of the planetary gear set.

### CROSS REFERENCE TO RELATED APPLICATION

This application claims the benefit of U.S. Provisional Application No. 62/095,932 filed Dec. 23, 2014, which is hereby incorporated by reference in its entirety.

### TECHNICAL FIELD

The present disclosure is generally related to bulk unloading systems, and more particularly, is related to grain unloading systems of a combine harvester.

### BACKGROUND

Combine harvesters harvest crop and then unload the harvested crop, such as grain, from grain bins residing on the combine harvester to the bed of a receiving vehicle, such as a truck bed, or other receptacle. A common mechanism for performing this function is by way of a conveyor, such as an auger, discharging the grain from the grain bin through a grain unloader tube that encompasses the auger. An operator seeking to top off the truck with grain typically encounters grain spillage due at least in part to the full-on manner of grain flow of the grain unloading operation, as well as experiencing high torque spikes when the mechanism is switched on.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic diagram that illustrates in side elevation view an example combine harvester in which an embodiment of a variable speed unloading system may be used.

FIG. 2 is a schematic diagram that illustrates an example grain bin and unloading system of the combine harvester depicted in FIG. 1 that may be driven by an embodiment of a variable speed unloading system.

FIG. 3A is a schematic diagram that illustrates an embodiment of an example variable speed unloading system.

FIG. 3B is a schematic diagram that illustrates another embodiment of an example variable speed unloading system.

FIG. 4A is a schematic diagram that illustrates a conventional output waveform for controlling conventional unloading systems.

FIGS. 4B-4E are schematic diagrams of various output waveforms achieved by an embodiment of a variable speed unloading system.

FIG. 5 is a block diagram that illustrates an embodiment of an example controller used in an embodiment of a variable speed unloading system.

FIG. 6 is a flow diagram that illustrates an embodiment of an example variable speed unloading method.

### DESCRIPTION OF EXAMPLE EMBODIMENTS

### Overview

In one embodiment, a system comprising: a planetary gear set configured to receive plural inputs and provide a variable output, the plural inputs comprising a first input and a second input; a motive system comprising an engine; a first clutch coupled to the motive system and configured to provide the first input; a variable speed drive system coupled to the motive system and configured to provide the second input; and an unloading system operatively coupled to the output of the planetary gear set.

### Detailed Description

Certain embodiments of a variable speed unloading system and method are disclosed that provide input speed control of an unloading system (e.g., grain unloading system) bulk flow rate and torque spike control (e.g., mitigation) for a. For instance, in some embodiments, the variable speed unloading system provides for slow-speed start-up of the unloading system, significantly mitigating torque spikes. In one embodiment, the variable speed unloading system comprises a differential mechanical drive comprising plural inputs (e.g., two) and a variable output, the output driving an unloading system. At start-up, a control system of the variable speed unloading system dampens torque spikes by slowing an output engagement rate by utilizing a secondary input. Certain embodiments of a variable speed unloading system enable an operator to control the unloading system to top-off trucks, carts, etc. by slowing the rate of grain flow out of the unloading apparatus.

Digressing briefly, in conventional unloading systems, an operator controls the grain flow discharged from the unloader tube, the grain flow provided at a constant flow rate (e.g., full-on, or single speed) when engaged. As flow rates and grain capacities increase, the operator's ability to reduce spillage when topping off a truck is compromised. Additionally, given that conventional systems are engaged, under load, at a single speed (e.g., corresponding to full power), conventional systems are subject to significant torque spikes, which may cause wear and tear on machine components (e.g., drive train, belts, pulleys, etc.). In contrast, certain embodiments of a variable speed unloading system enables an operator to control the rate of flow of grain (e.g., to provide variable flow) from the discharge of the unloader tube, avoiding or significantly mitigating the risk of overfill (and spillage) of grain into the grain cart or truck or other receptacle. For instance, as the grain level in the truck reaches capacity, the operator can slow the rate of flow to more precisely fill the truck. In some embodiments, the variable speed unloading system reduces the torque spikes conventionally experienced when starting an unloading system from a loaded position.

Having summarized certain features of a variable speed unloading system of the present disclosure, reference will now be made in detail to the description of the disclosure as illustrated in the drawings. While the disclosure is described in connection with these drawings, there is no intent to limit it to the embodiment or embodiments disclosed herein. For instance, a combine harvester is a focus of the disclosure of an example environment in which an embodiment of a variable speed unloading system may be used. However, in some embodiments, any machine equipped to discharge bulk material (e.g., grain, or other material) from a bulk material unloading system may similarly benefit from the features of a variable speed unloading system, and hence are contemplated to be within the scope of the disclosure. Further, although the description identifies or describes specifics of one or more embodiments, such specifics are not necessarily part of every embodiment. On the contrary, the intent is to cover all alternatives, modifications and equivalents included within the spirit and scope of the disclosure as defined by the appended claims. Further, it should be appreciated in the context of the present disclosure that the claims are not necessarily limited to the particular embodiments set out in the description.

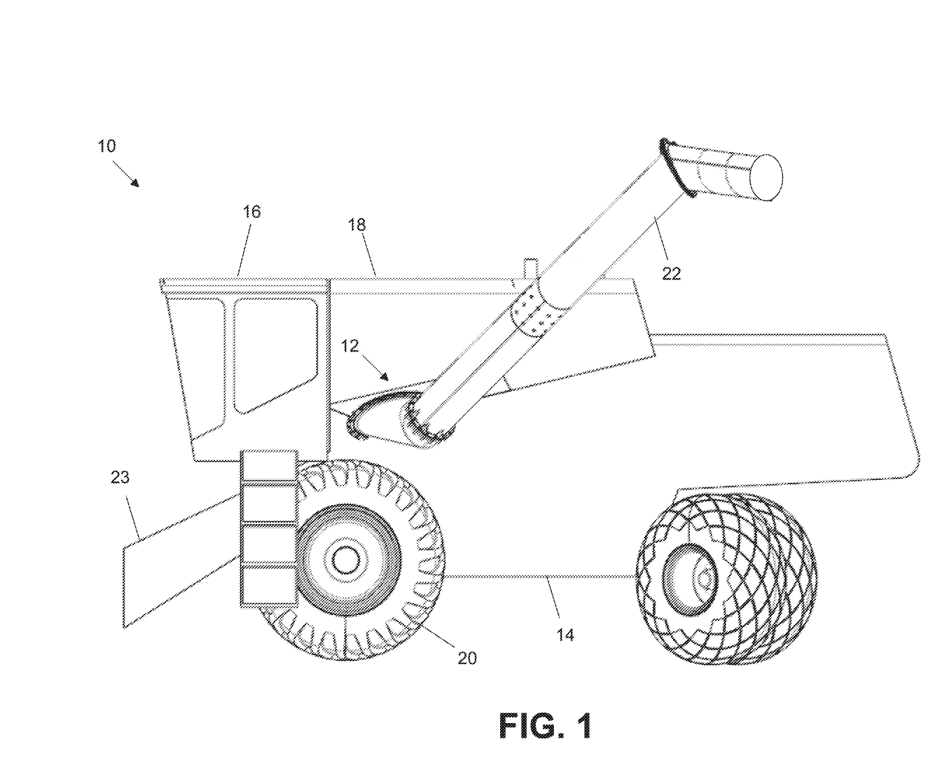

FIG. 1 is a schematic diagram that illustrates in side elevation view an example combine harvester 10 in which an embodiment of a variable speed unloading system 12 may be used. One having ordinary skill in the art should appreciate in the context of the present disclosure that the combine harvester 10 and associated components are merely illustrative, and that other configurations of a combine harvester, as well as other machines, may be used in some embodiments. The combine harvester 10 may be configured as one of a plurality of types of combine harvesters, including axial rotor, transverse rotor, hybrid, dual rotor, etc. As is known, the combine harvester 10comprises a chassis 14, a cab 16, a grain bin 18, and an engine and drive mechanisms that drive one or more wheels 20 (e.g., the front wheels in the depicted embodiment), as is well-known in the art. It should be appreciated that other mechanisms of travel may be used, such as track-based transportation and/or other axle configurations. The combine harvester 10 further comprises a grain unloading system comprising an unloader tube 22 (shown partially extended). Coupled to a feeder house 23 of the combine harvester 10 (e.g., at the cab end) is a harvesting header (not shown), as is conventionally known.

In operation, as is well understood by those having ordinary skill in the art, the harvesting header delivers collected crop materials to the front end of the feeder house 23. Such materials are moved upwardly and rearwardly within the feeder house 23, and further conveyed rearwardly to a rotary processing system, such as one or more rotors. The processing system performs threshing and separating according to known mechanisms. Threshing and separating generally involves the rotor(s) operating in cooperation with foraminous, arcuate processing members in the form of threshing concave assemblies and separator grate assemblies. Bulkier stalk and leaf materials are retained by the concave and grate assemblies and are impelled out the rear of the processing system and ultimately out of the rear of the combine harvester 10. Crop material expelled from the rotor and through the respective concave and separator grate assemblies flow through a cleaning system, which may comprise return and stratification pans and a shoe that comprises chaffer and sieve assemblies. With the aid of a fan or blower that provides forced air through a duct assembly to the shoe, lighter chaff particles are separated from the grain and passed out of the rear of the combine harvester 10, whereas the grain is conveyed (e.g., via a conveyor, such as an auger) to the grain bin 18. The grain bin 18 comprises one or more conveyors, such as an auger, that conveys the grain to the unloader tube 22. The unloader tube 22 is shown as a swivel-type unloader tube 22, though in some embodiments, the unloader tube 22 may be a turret style among other styles known in the art. The unloader tube 22 encircles a conveyor that receives the grain transferred from the conveyor residing in the grain bin 18. The conveyor within the unloader tube 22 delivers the grain past the discharge end (e.g., a swiveling head) of the unloader tube 22 and onto a bed of an accompanying grain cart or truck (e.g., while both are moving, or both are stationary), or in some implementations, discharges to a stationary receptacle, as is known.

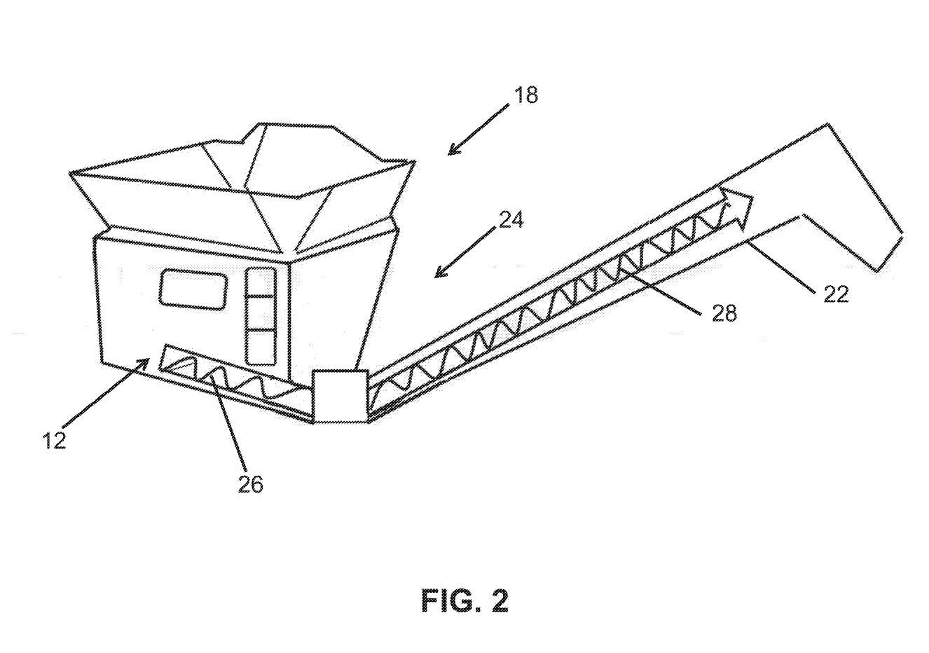

FIG. 2 is a schematic diagram that illustrates the grain bin 18 and an unloading system 24. It should be appreciated that the components depicted in FIG. 2 are merely illustrative, and that some embodiments may use different components and mechanisms. The grain bin 18 is shown with hopper-like extensions (not shown in FIG. 1) that provide extra holding capacity for the grain bin 18. Grain that has been threshed, separated, and cleaned by processing and cleaning mechanisms in the combine harvester 10 (FIG. 1) is elevated and temporarily stored in the grain bin 18 until unloaded either on-the-go or at a standstill into a suitable receptacle. The unloading system 24 comprises plural conveyors, such as conveyors 26 and 28. Note that the conveyors 26, 28 are depicted as augers, though some embodiments may use other components, such as belts, slats, etc. The conveyor 26 is disposed transversely within the lower region of the grain bin 18, and generally is disposed in a trough located at the bottom of the grain bin 18. The grain bin 18 comprises a number of inclined surfaces to take advantage of the gravitational pull on the grain, resulting in the deposit of the grain into the trough to be acted upon by the conveyor 26. The conveyor 26 is rotated in such a direction as to feed grain toward the conveyor 28 and unloader tube 22. In the depicted embodiment, the feeding direction is to the left (viewed from the rear of the combine harvester 10), but in some embodiments, the feed may be to the right. The conveyor 26 is operatively coupled (e.g., via a U-joint or other known coupling mechanism) at one end to the conveyor 28. The conveyor 28 is disposed within the unloader tube 22 and used to convey the grain from the grain bin 18 past the discharge end of the unloader tube 22 for deposit in a grain cart or truck or other receptacle, as is known. The other end of the conveyor 26 is operatively coupled to an output shaft that in turn is coupled to a planetary gear set of the variable speed unloading system 12. As is known, input power for driving the conveyor 26 may be provided by a sprocket that is entrained by a drive chain looped around a smaller sprocket on a jack shaft having a double sheave at its opposing end. The sheave is wrapped by endless belts that are operably coupled to an output shaft of the variable speed unloading system 12. In some embodiments, other known mechanisms may be used to couple the output of the variable speed unloading system 12 to the conveyor 26, such as via a U-joint, gearbox, etc.

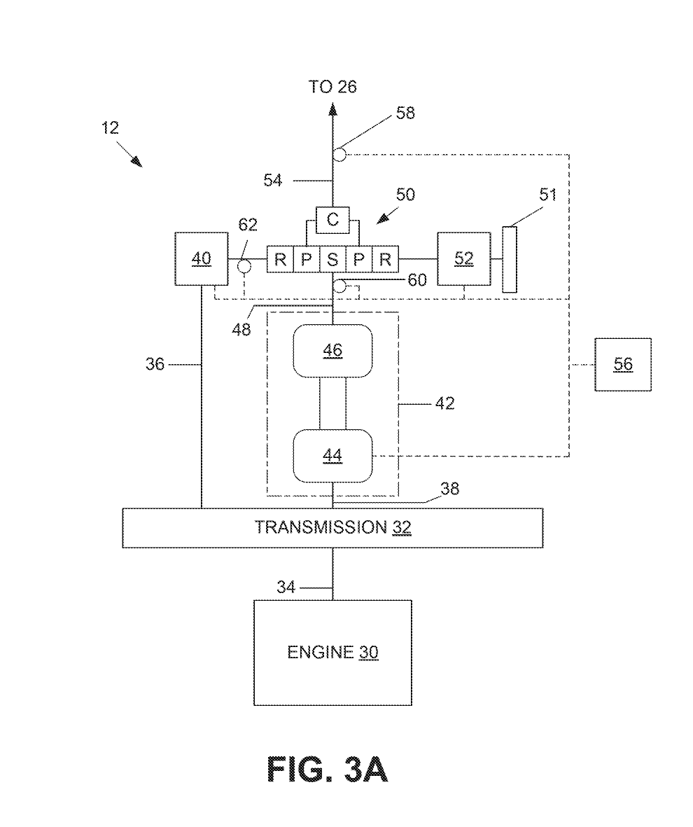

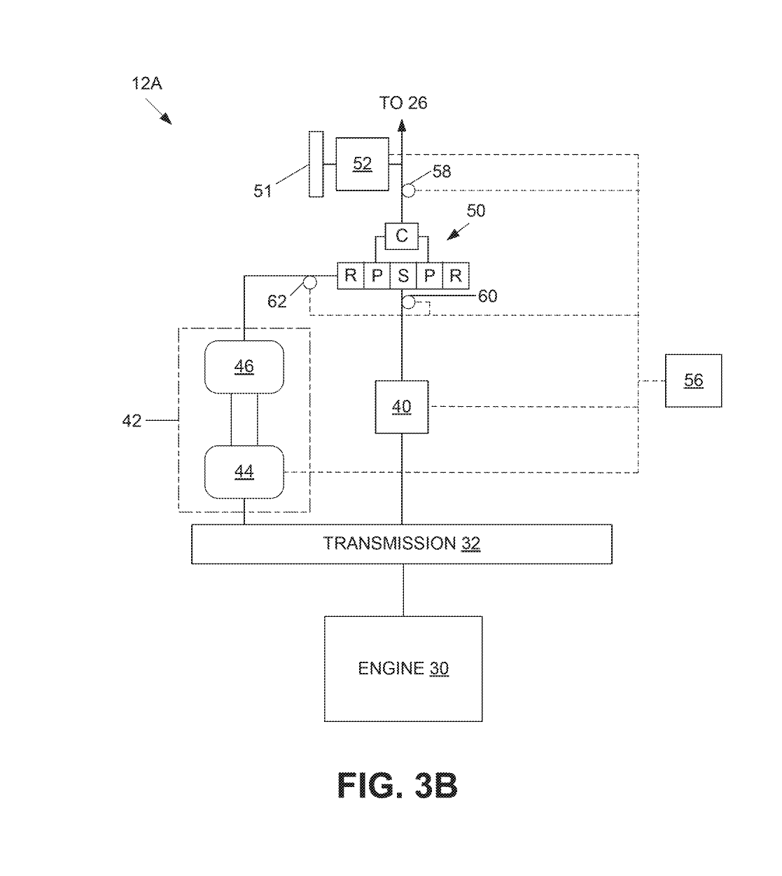

Having generally described an example environment in which an embodiment of a variable speed unloading system 12 may be implemented, attention is directed to FIG. 3A, which illustrates an embodiment of a variable speed unloading system 12. The arrangement of inputs and output depicted in FIG. 3A is illustrative of one example configuration, with the understanding that other configurations may be used as indicated below. The variable speed unloading system 12 comprises a power source, such as an internal combustion engine 30, coupled in one embodiment to a transmission 32 via a shaft 34. In one embodiment, the transmission 32 comprises a power take off (PTO) gearbox. Other components based on different forms of energy may be used in some embodiments. In some embodiments, the transmission 32 may be omitted from the variable speed unloading system 12. In the depicted embodiment, the transmission 32 is coupled to shafts 36 and 38 that are used to convey power to other components. All or a portion of the engine 30, transmission 32, and shafts 34, 36, and 38 may be referred to herein as a motive system. The variable speed unloading system 12 further comprises a clutch 40 coupled to the shaft 36 and a variable speed drive system, embodied in FIG. 3A as a hydro-static drive system 42, coupled to the shaft 38. Though the variable speed drive system depicted in FIG. 3A (and subsequently) comprises a hydro-static drive system 42, in some embodiments, other variable speed drive systems may be used, such as a variable speed belt drive, a second planetary gear set in stacked arrangement with the planetary gear set, among others known in the art. In other words, the hydro-static drive system 42 is used hereinafter as an example variable speed drive system, with the understanding that other variable speed drive systems may be used and hence are contemplated to be within the scope of the disclosure. In one embodiment, the hydro-static drive system 42 comprises a hydraulic pump 44 coupled to the shaft 38, a hydraulic motor 46 coupled via a hydraulic fluid medium to the hydraulic pump 44, and a shaft 48 coupled to the output of the hydraulic motor 46. The hydro-static drive system 42, through control of the hydraulic pump 44, provides a variable speed system, whereas the clutch 40 enables a substantially constant speed system (e.g., corresponding to the engine 30). In other words, when engaged, the engine 30 normally runs at a constant speed, though changes in engine speed may occur. In the embodiment depicted in FIG. 3A, the clutch 40 is coupled to a first gear (e.g., ring gear, denoted as “R” in FIG. 3A) of a planetary gear set 50, providing for the transfer of power from the motive system to an input to the planetary gear set 50. The hydro-static drive system 42 provides for the transfer of power to another gear (e.g., sun gear, denoted as “S” in FIG. 3A) according to a varying speed rotation of the coupled shaft 48. Also coupled the planetary gear set 50 is a brake clutch 52 (e.g., ring-to-frame clutch in the configuration shown in FIG. 3A, where the frame is denoted as frame 51). The clutch 40, particularly with hydraulic clutches, may still spin due to drag when the clutch 40 is disengaged. As is known, the brake clutch 52 locks up the system to mitigate or eliminate the spin of the other clutch 40, ensuring the output does not rotate when unintended. In some embodiments, the clutch 52 may be coupled to an output of the planetary gear set 50. The planetary gear set 50 further comprises a carrier (denoted as “C” in FIG. 3A), which is coupled to an output shaft 54. As noted above, the output shaft 54 is coupled to the conveyor 26 (FIG. 2) directly (e.g., U-joint) or via an intermediate device (drive-pulley system). The relative motion between the ring gear, sun gear, and carrier of the planetary gear set 50 enables the variable speed feature of the variable speed unloading system 12.

The operation of the variable speed unloading system 12 is based on the dual inputs from the clutch 40 and hydro-static drive system 42, and in general, the arrangement or configuration of inputs and gears. The configuration depicted in FIG. 3A results in the following connections to the planetary gear set 50 (Table 1):

TABLE 1

| | Input2 = Hydro-static drive | |
|---|---|---|
| Input1 = Clutch 40 output | system 42 output | Output |
| R | S | C |

In other words, the output is from the carrier to the output shaft 54, based on input to the sun gear from the hydraulic motor 46 and input to the ring gear from the clutch 40 (conveying the engine speed optionally through gearing of the transmission 32). Since the engine 30 runs at substantially constant speed, the ring gear does as well. The variable flows enabled by the hydraulic pump 44 and motor 46 enables independent speeds between the engine 30 and the motor 46. By changing the hydraulic motor speeds, a change in the ratio between the ring and sun gears is effected, enabling a change in the output speed of the carrier and hence output shaft 54. Stated generally, the speed and direction of the output is a function of both the speed and direction of the inputs 1 and 2.

It should be appreciated that the configuration shown in FIG. 3A is merely illustrative, and that other configurations may be achieved in some embodiments, as shown in Table 2 below (where inputs are from the output of clutch 40 for input 1 and the hydro-static drive system 42 for input 2, as in Table 1):

TABLE 2

| Input 1 | Input 2 | Output |
|---|---|---|
| S | R | C |
| S | C | R |
| R | C | S |
| C | R | S |
| C | S | R |

Referring to FIG. 3B, shown is another embodiment of a variable speed unloading system 12, designated as variable speed unloading system 12A and corresponding to the configuration at the top of Table 2. Similar components are used in FIG. 3B as in FIG. 3A, and discussion of the same is omitted here except where noted below. In this configuration, the inputs to the planetary gear set 50 comprise the output of the hydro-static drive system 42 provided to the ring gear (“R”) and the output of the clutch 40 to the sun gear (“S”). In other words, the planetary gear set 50 receives a variable speed input and a constant or substantially constant input at the ring gear and the sun gear, respectively. At the output is the brake clutch 52, though in some embodiments, the brake clutch 52 may be coupled to the ring gear as depicted in FIG. 3A.

It should be appreciated by one having ordinary skill in the art, in the context of the present disclosure, that variations in the structure and/or functionality may be implemented to achieve the desired result. For instance, though the hydro-static drive system 42 is illustrated in FIG. 3B as connected to the transmission 32 (e.g., the variable speed drive is in an active configuration), in some embodiments, the variable speed drive may be configured in a passive role. That is, the variable speed unloading system 12 may “bleed off” speed of the planetary ring to modulate the speed of the output, where in effect, the secondary input is back-driven and hence not an active driver. Note that in some implementations, a combination of active and passive configurations may be used.

With reference to FIGS. 3A-3B, in one embodiment, the variable speed unloading system 12 (and 12A) further comprises a control system comprising a controller 56 (e.g., electronic control unit or ECU) and a plurality of sensors 58, 60, and 62 (the sensors 58-62 schematically denoted as circles). The sensors 58-62are configured to detect input parameters to, and output parameters from, the planetary gear set 50, such as shaft speed (though in some embodiments, other parameters may be sensed), and may be contact or non-contact type sensors as are conventionally known. The sensor 58 senses shaft speed of the output shaft 54 or generally, carrier speed. The sensor 60 senses shaft speed of shaft 48 (e.g., of the output of the hydro-static drive system 42 in FIG. 3A or the output of the clutch 40 in FIG. 3B) or generally gear speed. The sensor 62 senses the other input to the planetary gear set 50 (e.g., generally gear speed), such as the output of the clutch 40 in FIG. 3A or the output of the hydro-static drive system 42 in FIG. 3B in the depicted configurations. Signals from the sensors 58-62 are communicated to the controller 56 via a wired (e.g., multiple wires of a logical CAN bus configuration, such as according to CAN ISO 11898, ISO 11783, etc.) and/or wireless medium (e.g., Bluetooth, WFi, etc.). In some embodiments, the wired medium may be arranged according to RS232, or other formats, protocols, or standards (e.g., proprietary). The controller 56 also communicates control signals to various components (e.g., actuators, solenoids, etc.) of the variable speed unloading system 12 (or 12A). The controller 56, in communicating the control signals (e.g., wirelessly and/or over a wired medium as with the signaling involving the sensors 58-62), may effect adjustment in operation of these components based on the signals from the sensors 58-62.In one embodiment, and using FIG. 3A as an example, the controller 56 provides control signals to the hydraulic pump 44 (e.g., the swash plate) to cause a change in the speed of rotation of the shaft 48 at the output of the hydro-static drive system 42. The controller 56 further provides control signals to a respective actuator of the clutches 40 and 52. The aforementioned signaling or communication medium is depicted via dashed lines between the controller 56 and the respective components.

In some embodiments, the control system comprises a user interface (not shown) that enables manual control by an operator of the variable speed unloading system 12 (or 12A), and in some embodiments, the user interface may be used in conjunction with the controller 56 (e.g., to enable feedback of operations and/or interactive control). The user interface may be embodied as one or any combination of a lever, switch (e.g., rotating switch), graphical user interface (e.g., display screen, such as with touch screen capability or in conjunction with a peripheral device, immersive headset, etc.), microphone for enabling verbal commands, among others well-known in the art.

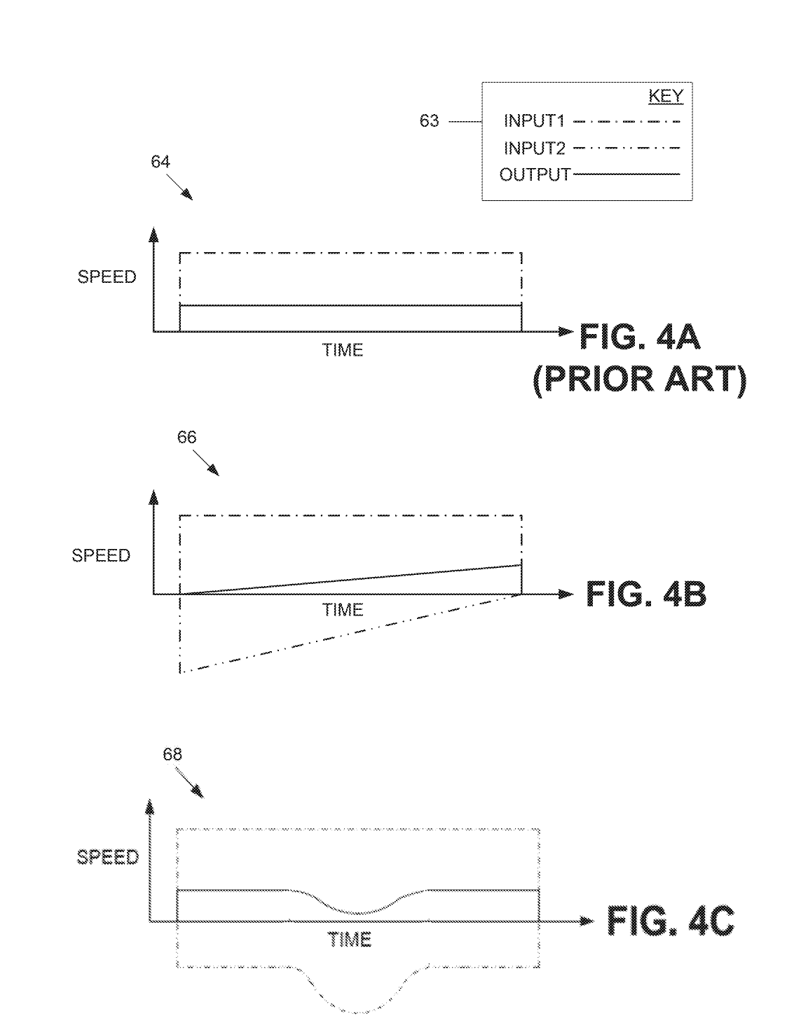

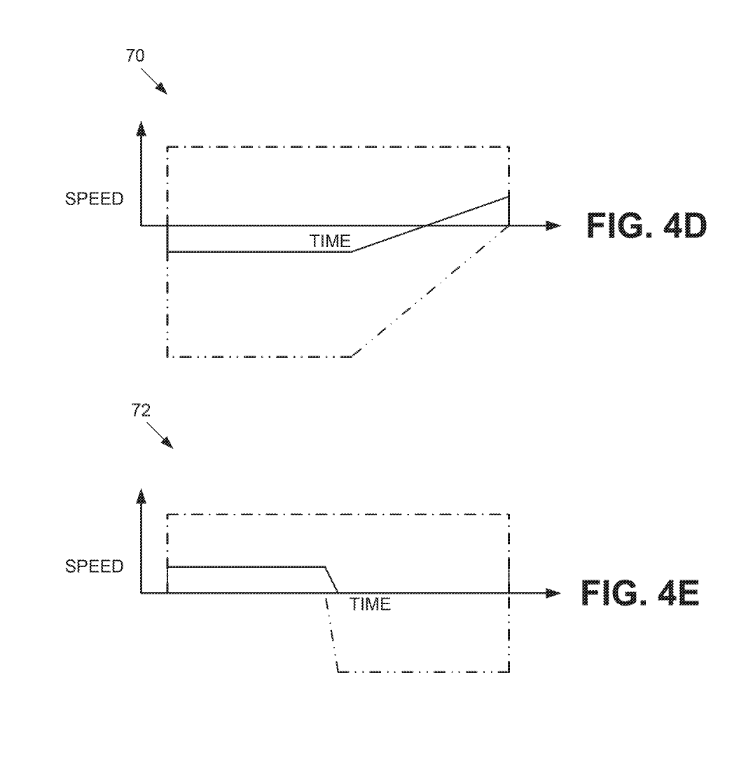

Referring now to FIGS. 4A-4E, shown are schematic diagrams of various output waveforms achieved, at least in part, in an embodiment of a variable speed unloading system 12 (or 12A). Note that reference hereinafter to variable speed unloading system 12 encompasses systems 12 (FIG. 3A), 12A (FIG. 3B), as well as the other configurations listed in Table 2 above. In particular, FIGS. 4B-4E represent sample waveforms that may be achieved at the output of the planetary gear set 50 (e.g., via output shaft 54) based on primary (e.g., input 1) and secondary (e.g., input 2) inputs to the planetary gear set 50 based on signaling from the controller 56 and the various configurations shown in Tables 1 and 2. Shown in FIG. 4A is a key 63 applicable to FIGS. 4A-4E, where dashes are separated by a single dot to correspond to input 1 (the constant or substantially constant input or primary input), dashes are separated by two dots to correspond to input 2 (the variable speed input or secondary input), and a solid line corresponds to the output. In each of the FIGS. 4A-4E, the vertical (y) axis corresponds to output speed, and the horizontal (X) axis corresponds to time. FIG. 4A corresponds to a prior art waveform 64 associated with a fixed-speed drive, where there is only one input (primary input) that causes the system to come on and stay on while the input is active (i.e., the output follows the input). FIG. 4B (and FIGS. 4C-4E) correspond to variable speed drives associated with certain embodiments of a variable speed unloading system 12. In particular, FIG. 4B corresponds to a soft-start output waveform 66. A soft start output provides a mechanism by which torque spikes can be mitigated. In soft start, the primary input corresponds to the primary input spinning at a forward speed and the secondary input spinning at a negative speed, resulting in no movement at the output. Then, while maintaining the primary input at the forward speed, the secondary input speed is decreased slowly (e.g., negative speed closing to zero) resulting in an output that gradually ramps up in speed. FIG. 4C corresponds to a variable speed waveform 68, where once again the primary input (e.g., corresponding to the substantially constant engine speed) is set, and the secondary input runs at a negative speed, momentarily becoming more negative at the downward directed curve shown in FIG. 4C, then returning to the original negative speed, resulting in the corresponding variable speed waveform 68. FIG. 4D corresponds to an output-reversing waveform 70, which may be uses to unclog the unloading system 24 (FIG. 2). Similar to the waveforms 66-68 of FIGS. 4B-4C, respectively, the primary input runs at full speed, and the secondary input is initially run at an extreme negative speed, causing the output to be negative (reverses, or spins backwards). The secondary input then progresses (less negative) until closing to zero, with a corresponding output speed that becomes positive (forward spinning). FIG. 4D corresponds to a rapid output disconnect (sensed overload) waveform 72. For instance, if an overload condition is sensed, there is a need or desire to shut down quickly. As shown, the primary input corresponds to a positive full speed, resulting in a forward spin output. When there is a need or desire to shut down, the secondary input corresponds to an abrupt negative speed, which draws the output speed to zero. It should be appreciated that these waveforms are merely illustrative of certain examples, and that in some embodiments, other waveforms may be provided. Note that in embodiments using a passive configuration (e.g., no input from the transmission to the variable speed drive), outputs corresponds to FIGS. 4B, 4C, and 4E may be supported.

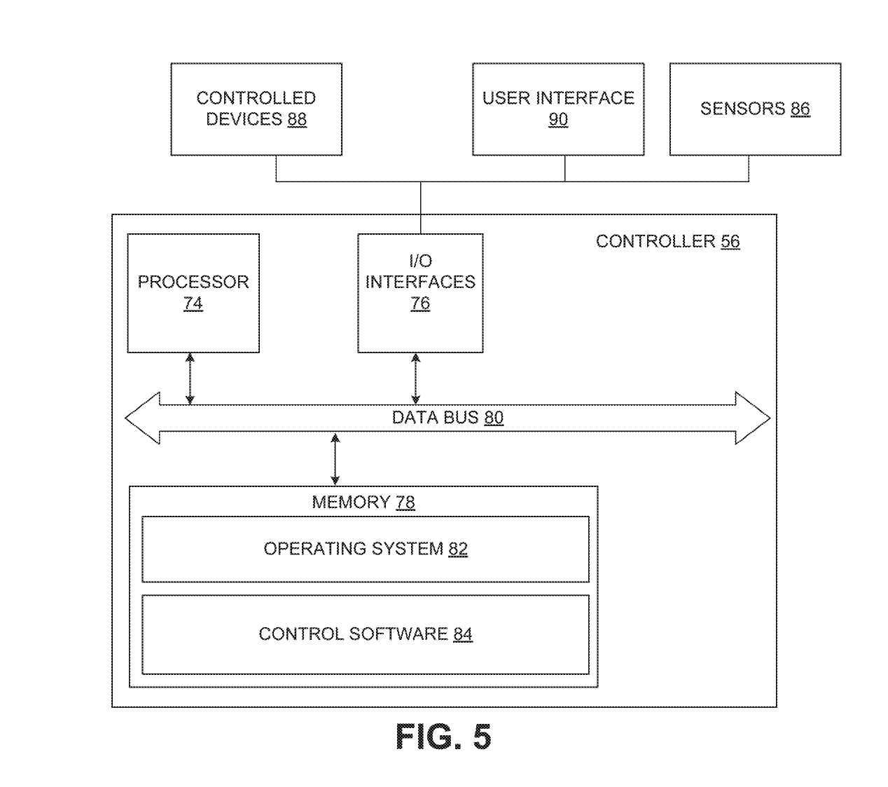

Attention is now directed to FIG. 5, which illustrates an embodiment of an example controller 56that may be used to provide automated or semi-automated control of an embodiment of a variable speed unloading system 12. One having ordinary skill in the art should appreciate in the context of the present disclosure that the example controller 56 is merely illustrative, and that some embodiments of controllers may comprise fewer or additional components, and/or some of the functionality associated with the various components depicted in FIG. 5 may be combined, or further distributed among additional modules or controllers, in some embodiments. It should be appreciated that, though described in the context of residing in the combine harvester 10 (FIG. 1), in some embodiments, the controller 56, or all or a portion of its corresponding functionality, may be implemented in a computing device or system located external to the combine harvester 10. Referring to FIG. 5, with continued reference to FIGS. 1-4E, the controller 56 is depicted in this example as a computer system, but may be embodied as a programmable logic controller (PLC), field programmable gate array (FPGA), application specific integrated circuit (ASIC), among other devices. It should be appreciated that certain well-known components of computer systems are omitted here to avoid obfuscating relevant features of the controller 56. In one embodiment, the controller 56 comprises one or more processors, such as processor 74, input/output (I/O) interface(s) 76, and memory 78, all coupled to one or more data busses, such as data bus 80. The memory 78 may include any one or a combination of volatile memory elements (e.g., random-access memory RAM, such as DRAM, and SRAM, etc.) and nonvolatile memory elements (e.g., ROM, hard drive, tape, CDROM, etc.). The memory 78may store a native operating system, one or more native applications, emulation systems, or emulated applications for any of a variety of operating systems and/or emulated hardware platforms, emulated operating systems, etc.

In the embodiment depicted in FIG. 5, the memory 78 comprises an operating system 82 and control software 84. It should be appreciated that in some embodiments, additional or fewer software modules (e.g., combined functionality) may be deployed in the memory 78 or additional memory. In some embodiments, a separate storage device, such as a persistent memory (e.g., optical, magnetic, and/or semiconductor memory and associated drives), may be coupled to the data bus 80 or coupled to a network via the I/O interfaces 76. The storage device may be a removable device, such as a memory stick or disc.

In one embodiment, the control software 84 is executed by the processor 74 to receive sensor input to determine one or more parameters of the variable speed unloading system 12. The control software 84 processes the sensor input from sensors 86 (which includes sensors 58-62, FIGS. 3A-3B) via I/O interfaces 76 and responsively provides control signals to controlled devices 88 (e.g., clutches 40, 52 and hydraulic pump 44) via the I/O interfaces 76 to cause the output waveforms shown in FIGS. 4B-4E. In other words, control software 84 uses the sensor inputs to determine the adjustments to the output shaft speed to effect slow-start, granular flow rate control, reverse operation (e.g., to remedy plugging), etc. In some embodiments, inputs may be received from a user interface 90 (e.g., a switch, button, lever, graphical user interface, microphone, etc.) in lieu of, or in combination with, the sensor input. In some embodiments, the sensors 86 may play a more passive role in the variable speed unloading system 12. For instance, the control software 84 may provide the control signals necessary to provide operations as shown in FIGS. 4B-4E based on a calibration process (e.g., at start-up, such as at the manufacturer facility), and the sensors 86 are used to fine-tune the target output speed or provide a trouble-shooting feature (e.g., alert when set points not reached or operation is not as programmed) during normal operations.

Execution of the control software 84 may be implemented by the processor 74 under the management and/or control of the operating system 82. For instance, as is known, source statements of the control software 84 may be translated by one or more compilers of the operating system 82 to assembly language and then further translated to a corresponding machine code that the processor 74 executes to achieve the functionality of the control software 84. Variations of this execution process are known, depending on the programming language of the software. For instance, if Java-based, the compiled output may comprise bytecode that may be run on any computer system platform for which a Java virtual machine or bytecode interpreter is provided to convert the bytecode into instructions that can be executed by the processor 74. Also, register transfer language (or other hardware description language) may be used to translate source code to assembly language, which the one or more operating system compilers translate to executable machine code. In some embodiments, the operating system 82 may be omitted and a more rudimentary manner of control implemented.

The processor 74 may be embodied as a custom-made or commercially available processor, a central processing unit (CPU) or an auxiliary processor among several processors, a semiconductor based microprocessor (in the form of a microchip), a macroprocessor, one or more application specific integrated circuits (ASICs), a plurality of suitably configured digital logic gates, and/or other well-known electrical configurations comprising discrete elements both individually and in various combinations to coordinate the overall operation of the controller 56.

The I/O interfaces 76 provide one or more interfaces to one or more devices, such as the sensors 86, the controlled devices 88, and the user interface 90, among other devices that are coupled directly or indirectly (e.g., over a bus network, such as a CAN network, including one operating according to ISO-bus) to the controller 56. The I/O interfaces 76 may also comprise functionality to connect to other networks. For instance, the I/O interfaces 76 may include a network interface that enables remote or wireless communications, such as via well-known telemetry functionality, WiFi, Blue-tooth communications, near-field, among other electromagnetic spectrum communications. In some embodiments, remote communications may be achieved via other devices coupled to the controller 56.

When certain embodiments of the controller 56 are implemented at least in part with software (including firmware), as depicted in FIG. 5, it should be noted that the software can be stored on a variety of non-transitory computer-readable medium for use by, or in connection with, a variety of computer-related systems or methods. In the context of this document, a computer-readable medium may comprise an electronic, magnetic, optical, or other physical device or apparatus that may contain or store a computer program (e.g., executable code or instructions) for use by or in connection with a computer-related system or method. The software may be embedded in a variety of computer-readable mediums for use by, or in connection with, an instruction execution system, apparatus, or device, such as a computer-based system, processor-containing system, or other system that can fetch the instructions from the instruction execution system, apparatus, or device and execute the instructions.

When certain embodiments of the controller 56 are implemented at least in part with hardware, such functionality may be implemented with any or a combination of the following technologies, which are all well-known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

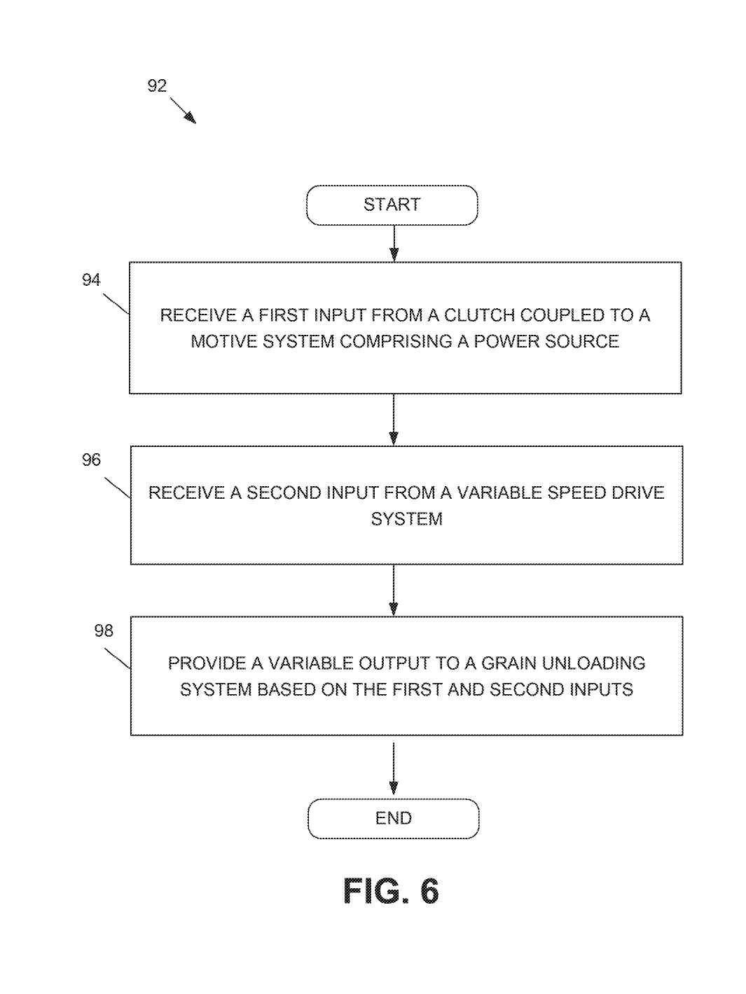

Having described some example embodiments of a variable speed unloading system 12, it should be appreciated in view of the present disclosure that one embodiment of a variable speed unloading method, the method depicted in FIG. 6 and denoted as method 92, comprises receiving a first input from a clutch coupled to a motive system comprising a power source (94); receiving a second input from a variable speed drive system (96); and providing a variable output (e.g., continuously variable, such as shown in FIGS. 4A-4E) to a grain unloading system based on the first and second inputs (98).

Any process descriptions or blocks in flow charts should be understood as representing steps in the process, and alternate implementations are included within the scope of the embodiments in which functions may be executed out of order from that shown or discussed, including substantially concurrently, depending on the functionality involved, as would be understood by those reasonably skilled in the art of the present disclosure.

It should be emphasized that the above-described embodiments of the present disclosure are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

1. A system, comprising:
a planetary gear set configured to receive plural inputs and provide a variable output, the plural inputs comprising a first input and a second input;
a motive system comprising an engine;
a first clutch coupled to the motive system and configured to provide the first input;
a variable speed drive system coupled to the motive system and configured to provide the second input; and
an unloading system operatively coupled to the output of the planetary gear set.

2. The system of claim 1, wherein the unloading system comprises a grain unloader tube and plural conveyors configured to cause a variable flow of grain through the unloader tube.

3. The system of claim 1, wherein the variable speed drive comprises one of a hydrostatic drive system, a variable speed belt drive, or a second planetary gear set in stacked arrangement with the planetary gear set.

4. The system of claim 1, wherein the motive system further comprises a transmission system coupled to an output of the engine.

5. The system of claim 1, wherein the planetary gear set comprises:
a first gear configured to receive one of the first or second inputs;
a second gear configured to receive the other of the first or second inputs; and
a carrier configured to provide the output based on the first and second inputs.

6. The system of claim 1, wherein the planetary gear set comprises:
a carrier configured to receive one of the first or second inputs;
a first gear configured to receive the other of the first or second inputs; and
a second gear configured to provide the output based on the first and second inputs.

7. The system of claim 1, further comprising a control system, the control system comprising:
a controller; and
plural sensors coupled to the controller and configured to provide information to the controller, wherein the controller is configured to control the first clutch, a second clutch, and the hydrostatic drive system.

8. The system of claim 7, wherein the plural sensors comprise:
a first sensor configured to detect a parameter corresponding to the second input;
a second sensor configured to detect a parameter corresponding to the first input; and
a third sensor configured to detect a parameter corresponding to the output of the planetary gear set.

9. The system of claim 7, wherein the second clutch comprises a braking clutch coupled to a gear of the planetary gear set or an output of the planetary gear set.

10. The system of claim 1, further comprising a user interface configured to receive user input, wherein control of the first clutch, a second clutch coupled to the planetary gear set, and the variable speed drive system is based on the user input.

11. A machine, comprising:
a chassis supported by wheels or tracks;
a motive system comprising an engine, the motive system supported by the chassis;
a grain bin supported by the chassis;
an unloading system comprising:
a grain unloader tube; and
plural conveyors, wherein at least one of the plural conveyors is disposed in the grain bin and another of the conveyors is disposed within the unloader tube;
a planetary gear set coupled to an output shaft, the output shaft coupled to the at least one of the plural conveyors;
a first clutch coupled between the motive system and the planetary gear set; and
a variable speed drive system coupled to the planetary gear set.

12. The machine of claim 11, wherein the variable speed comprises one of a hydrostatic drive system, a variable speed belt drive, or a second planetary gear set in stacked arrangement with the planetary gear set.

13. The machine of claim 11, wherein the motive system further comprises a transmission system coupled to an output of the engine.

14. The machine of claim 11, wherein the planetary gear set comprises:
a first gear coupled to one of the first clutch or the variable speed drive system;
a second gear coupled to the other of the first clutch or the variable speed drive system;
and
a carrier coupled to the output shaft.

15. The machine of claim 11, wherein the planetary gear set comprises:
a carrier coupled to one of the first clutch or the variable speed drive system;
a first gear coupled to the other of the first clutch or the variable speed drive system; and
a second gear coupled to the output shaft.

16. The machine of claim 11, further comprising a control system, the control system comprising:
a controller; and
plural sensors coupled to the controller and configured to provide information to the controller, wherein the controller is configured to control the first clutch, a second clutch, and the hydrostatic drive system.

17. The machine of claim 16, wherein the plural sensors comprise:
a first sensor configured to detect a parameter corresponding to a first input to the planetary gear set;
a second sensor configured to detect a parameter corresponding to a second input to the planetary gear set; and
a third sensor configured to detect a parameter corresponding to the output shaft.

18. The machine of claim 16, wherein the second clutch comprises a braking clutch coupled to a gear of the planetary gear set or an output of the planetary gear set.

19. The machine of claim 11, wherein the variable speed drive system is either coupled between the motive system and the planetary gear set or decoupled from the motive system.

20. A method, comprising:
receiving a first input from a clutch coupled to a motive system comprising a power source;
receiving a second input from a variable speed drive system; and
providing a variable output to a grain unloading system based on the first and second inputs.
